(19) United States
(12) Patent Application Publication
(10) Pub. No.: US 2011/0042368 A1
(43) Pub. Date: Feb. 24, 2011

(54) ELECTRICAL HEATING ARRANGEMENT

(75) Inventor: Brian Roger Alves, Malvern (GB)

Correspondence Address: Law Office of Ira S Dorman, 330 Roberts Street, Suite 200, East Hartford, CT, 06108, US

(73) Assignee: CERAMASPEED LIMITED, Worcestershire (GB)

(21) Appl. No.: 11/795,935

(22) PCT Filed: Feb. 1, 2006
(86) PCT No.: PCT/GB2006/000314

§ 371 Date: Apr. 25, 2008

(30) Foreign Application Priority Data
Feb. 5, 2005 (GB) 0502390.8

(51) Int. Cl. H05B 3/68

(52) U.S. Cl. 219/448.13; 219/448.11; 219/448.17

(57) ABSTRACT

An electrical heating arrangement (2) includes a temperature sensor assembly which comprises a housing member (34) mounted on, and extending partially across, a heater (12). The housing (34) has a first end region (36) in spaced relationship with an electric heating element (20), and a second end region (38) which traverses and extends externally of a peripheral wall (18). A first temperature-sensitive electrical element (52) is provided at the first end region (36) of the housing (34) and first electrical leads (54) extend to the second end region (38) of the housing (34). A layer (58) of thermal insulation material is provided and a second temperature-sensitive electrical element (60) overlies the layer (58). The second element (60) is provided at the first end region (36) of the housing (34) and second electrical leads (62) extend to the second end region (38) of the housing (34). Securing means (104) is provided securing the housing (34) to the heater (12) with an upper surface of the temperature sensor assembly (30) located substantially in contact with the lower surface (10) of a cooking plate (4).

This invention relates to an electrical heating arrangement in a cooking appliance incorporating a cooking plate, such as of glass-ceramic, which has an upper surface for receiving a cooking utensil and a lower surface having supported in contact therewith an electric heater incorporating at least one electric heating element, and a temperature sensor assembly.

It is known to provide an electric heating arrangement for a cooking appliance in which a temperature sensing device is arranged under a glass-ceramic cooking plate in order to monitor the temperature of a cavity between a heating element of an electric heater and an underside of the glass-ceramic plate, whereby to monitor the temperature of the glass-ceramic plate and to operate to control energising of the heating element, particularly to ensure that the temperature of the glass-ceramic plate does not exceed a safe limit value. Such a temperature sensing device is known to comprise a temperature-sensitive electrical resistance element supported on a suitable substrate and arranged to be subjected to direct thermal radiation from the heating element.

A problem can arise with such a temperature sensing device in that thermal radiation incident from an underlying region of the heating element on the device may be reflected back from the device to the underlying region of the heating element. As a result, such underlying region of the heating element may reach an undesirably high temperature, which may lead to premature failure of the heating element.

A different requirement relates to the sensing of temperature of a cooking utensil located on the upper surface of a cooking plate, using a temperature sensing device provided underneath the cooking plate. Here it is required to be able to measure small changes in temperature in the cooking plate overlying the temperature sensing device and good thermal coupling is required between the temperature sensing device and the cooking plate. However, if the temperature sensing device also receives direct thermal radiation from the heating element in the underlying heater, this makes it difficult to distinguish small changes in temperature of the cooking plate associated with the overlying cooking utensil.

It is known to provide a temperature responsive electrical device urged in contact with a region of a lower surface of the cooking plate and surrounded by a thermally insulating enclosure. However, such an arrangement is cumbersome and it may be difficult to ensure maintenance of good and uniform contact between the temperature-responsive device and the lower surface of the cooking plate.

The provision of two separately formed temperature sensing devices in an electrical heating arrangement to fulfil the two requirements of monitoring cooking utensil temperature and cooking plate temperature is inconvenient and expensive and it is an object of the present invention to overcome or minimise this problem.

According to the present invention there is provided an electrical heating arrangement comprising: a cooking plate having an upper surface for receiving a cooking utensil, and a lower surface; an electric heater incorporating at least one electric heating element, the heater having a peripheral wall adapted for contacting the lower surface of the cooking plate; and a temperature sensor assembly, the temperature sensor assembly comprising: a housing member mounted on the heater and extending at least partially across the heater and having a first end region in spaced relationship with the at least one electric heating element, and a second end region traversing and extending externally of the peripheral wall; a first temperature-sensitive electrical element provided at the first end region of the housing member and having first electrical leads extending to the second end region of the housing member; a layer of thermal insulation material; a second temperature-sensitive electrical element separate from the first temperature-sensitive electrical element and overlying the layer of thermal insulation material, the second temperature-sensitive electrical element being provided at the first end region of the elongate housing member and having second electrical leads extending to the second end region of the housing member; and means securing the housing member relative to the heater with an upper surface of the temperature sensor assembly located substantially in contact with the lower surface of the cooking plate.

The layer of thermal insulation material may overlie the first temperature-sensitive electrical element and may additionally overlie at least part of the first electrical leads.

The second temperature-sensitive electrical element may be arranged whereby an upper surface thereof is substantially coplanar with an upper surface of the housing member.

The first and second temperature-sensitive electrical elements may each comprise a device having an electrical parameter which changes as a function of temperature.

The first and/or second temperature-sensitive electrical element may comprise a thermocouple or a device having an electrical resistance which changes as a function of temperature, such as a platinum resistance temperature detector.

The first temperature-sensitive electrical element may comprise a chip-form electrical resistance temperature detector, or a thermocouple, provided with first electrical leads of wire or tape form.

The second temperature-sensitive electrical element may comprise a temperature-sensitive electrical resistance element of film or foil form, provided on an electrically insulating substrate. The electrically insulating substrate may be of elongate form, extending to the second end region of the housing member.

The second electrical leads may be of film or foil form provided on the elongate electrically insulating substrate.

The electrically insulating substrate may comprise alumina, steatite, forsterite, glass-ceramic, fused silica, quartz, celsian, aluminium titanate, cordierite, zirconia, alumina-zirconia blends, silicon nitride, or a thin metal strip provided with a coating of a dielectric material.

The electrically insulating substrate may comprise alumina of at least substantially 80 percent purity.

The electrically insulating substrate may comprise stainless steel provided with a coating of the dielectric material.

The substrate may have a thickness from about 0.25 mm to about 3 mm and preferably from about 0.5 mm to about 1 mm.

One or more electrically insulating or passivation layers or members may be provided overlying the second temperature-sensitive electrical element and optionally at least part of the second electrical leads.

Electrical terminal means may be provided, secured at the second end region of the housing member and electrically connected to the first and second electrical leads and adapted for electrical connection of the first and second temperature-sensitive electrical elements to external control circuit means. Such electrical terminal means may comprise or be secured by rivets, bolts or pins provided in holes through the second end region of the housing member.

The first temperature-sensitive electrical element may be arranged for monitoring temperature of the lower surface of the cooking plate or of a cavity formed between the at least one heating element and the cooking plate.

The second temperature-sensitive electrical element may be arranged for monitoring temperature of the cooking utensil through the cooking plate.

The cooking plate may comprise glass-ceramic material.

The housing member may comprise ceramic material, such as alumina, steatite or cordierite.

The first end region of the housing member may have an external lower surface contoured in such a way that thermal radiation incident thereon from an underlying region or regions of the at least one heating element is not substantially all reflected back to such underlying region or regions, whereby undesirably high temperature of the at least one heating element at such region or regions is minimised or reduced.

Contouring of the external lower surface of the first end region of the housing member may be such as to effect wide-angle reflection of the thermal radiation incident thereon from the underlying region or regions of the at least one heating element. Such wide-angle reflection of the incident thermal radiation may be diffuse reflection.

The external lower surface of the first end region of the housing member may be contoured whereby it is of outwardly-bulging, bulbous or convex form or has two or more inclined substantially planar faces.

Contouring of the external lower surface of the first end region of the housing member may extend over substantially a full length of the first end region adapted to extend within the heater from the peripheral wall.

The layer of thermal insulation material may be provided with an upstanding rim laterally bordering one or more side edges of the second temperature-sensitive electrical element.

The layer of thermal insulation material may extend along at least the first end region of the housing member and may extend along at least part of the second end region of the elongate housing member, at least where the second end region traverses the peripheral wall of the heater.

The layer of thermal insulation material may serve to thermally insulate the second temperature-sensitive electrical element from thermal radiation incident on the housing member from the at least one electric heating element in the heater and/or to provide protection for the first temperature-sensitive electrical element and/or the first electrical leads and/or to provide support for the second temperature-sensitive electrical element and/or the second electrical leads.

The layer of thermal insulation material may also provide electrical insulation.

The layer of thermal insulation material may comprise microporous thermal insulation material and/or granular thermal insulation material. The granular thermal insulation material may comprise vermiculite or calcium silicate.

The layer of thermal insulation material may have a thickness from about 1 mm to about 4 mm and preferably from about 2 mm to about 3 mm.

The layer of thermal insulation material may be press-moulded into the housing member.

The means for securing the housing member to the heater may comprise a mounting bracket, such as of metal, for example steel, which may be of plated or stainless form, which mounting bracket may include spring means to bias the housing member towards the lower surface of the cooking plate, whereby the upper surface of the temperature sensor assembly is located substantially in contact with the lower surface of the cooking plate.

The mounting bracket may comprise a base portion, such as of contoured strip-like form, secured to an external edge of the heater, such as by threaded fastener means, and a pair of spaced-apart upstanding slotted portions extending from the base portion and slidingly engaging complementary contoured opposite side regions of the housing member, compression coil spring means being provided, cooperating between the base portion and an external lower surface region of the housing member, whereby the housing member is urged towards the lower surface of the cooking plate.

The base portion may be provided with an upstanding locating portion for receiving the coil spring means.

The complementary contoured opposite side regions of the housing member may comprise slots containing web-like projections slidingly engaging the slotted portions of the mounting bracket.

The upstanding slotted portions of the mounting bracket may be substantially U-shaped and may open upwardly.

Retaining means may be provided for retaining the mounting bracket in assembly with the housing member. Such retaining means may comprise a laterally extending lug portion on one or both of the upstanding slotted portions, engaging with stop means provided on one or both opposite side regions of the housing member.

The upstanding slotted portions of the mounting bracket may be provided with hook-like projections engaging with the external edge of the heater, to provide enhanced securement of the mounting bracket to the heater.

For a better understanding of the present invention and to show more clearly how it may be carried into effect, reference will now be made, by way of example, to the accompanying drawings in which:

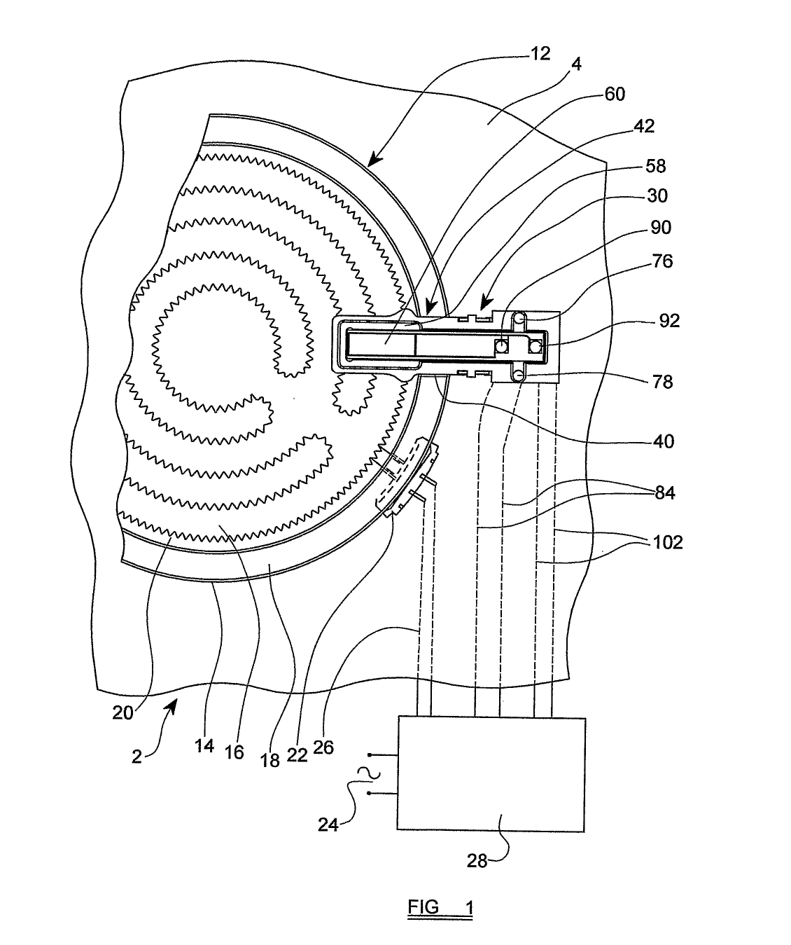

FIG. 1 is a plan view of an embodiment of an electrical heating arrangement according to the present invention;

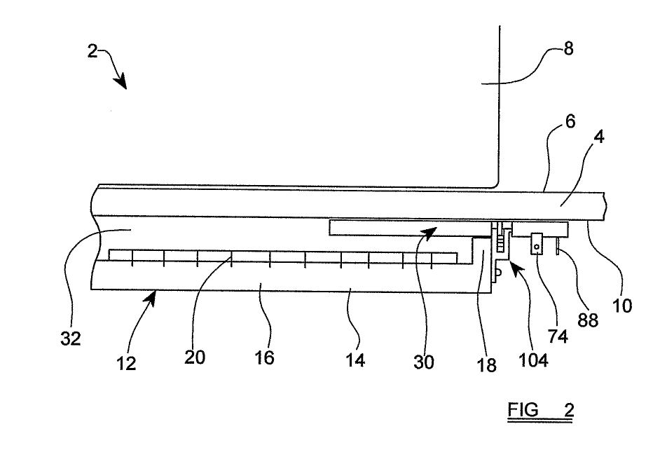

FIG. 2 is a cross-sectional view of the arrangement of FIG. 1:

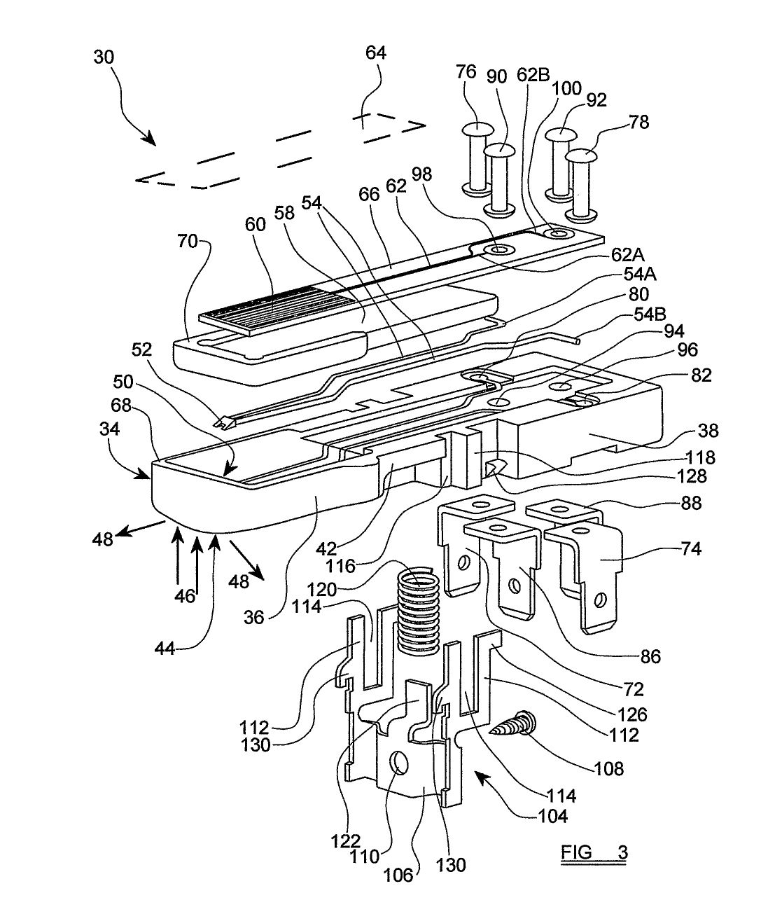

FIG. 3 is an exploded perspective view of an embodiment of temperature sensor assembly for use in the arrangement of FIGS. 1 and 2;

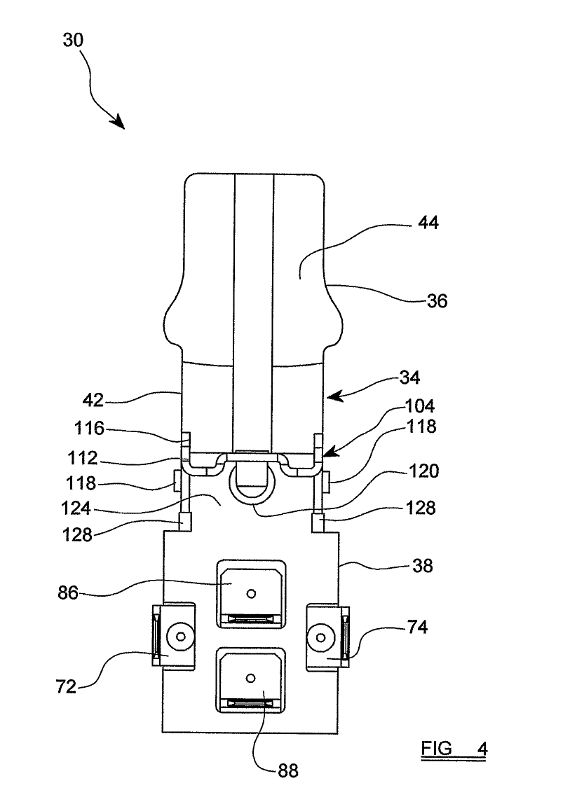

FIG. 4 is an underside view of the temperature sensor assembly of FIG. 3;

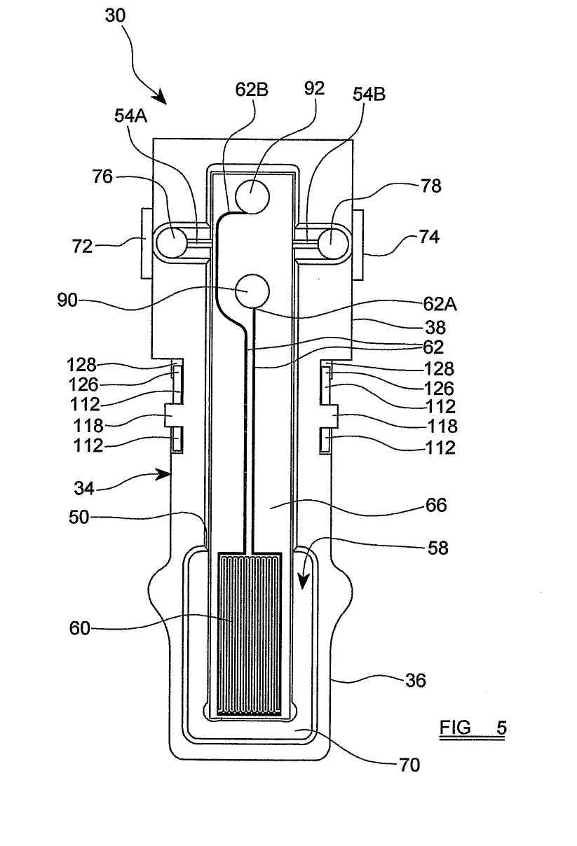

FIG. 5 is a top view of the temperature sensor assembly of FIG. 3;

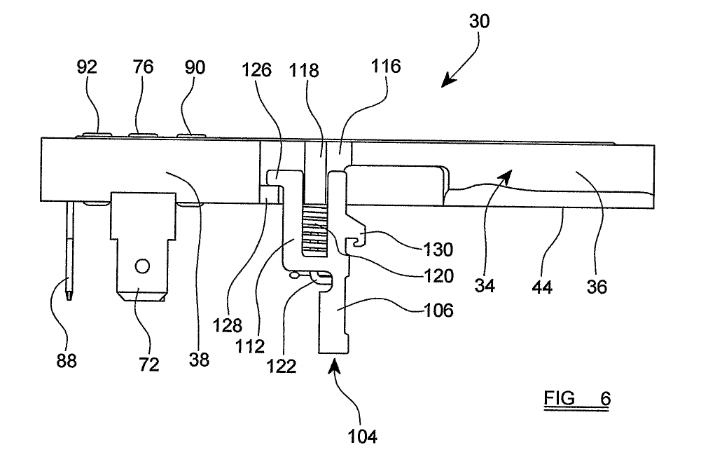

FIG. 6 is a side view of the temperature sensor assembly of FIG. 3;

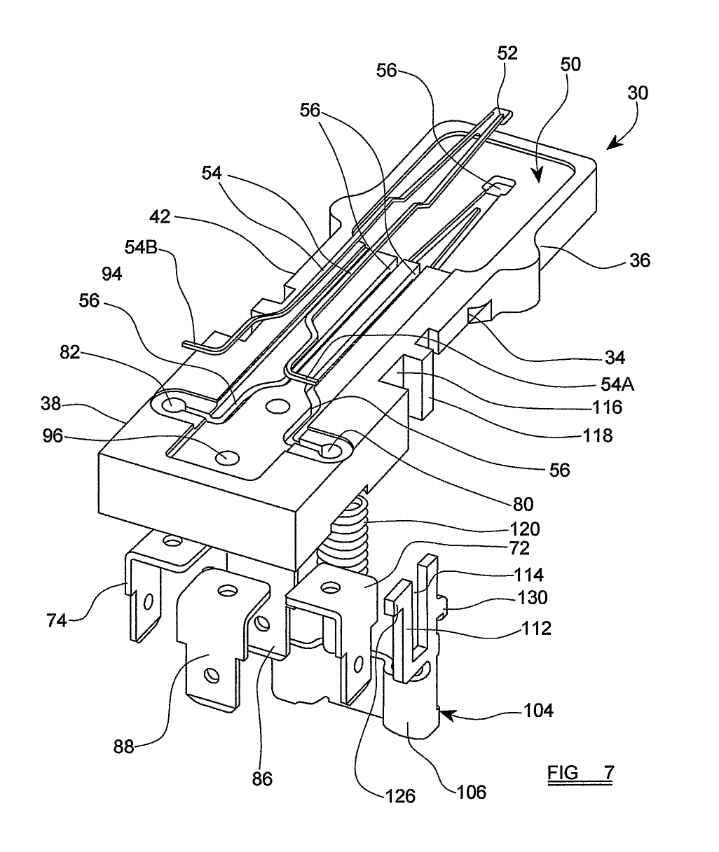

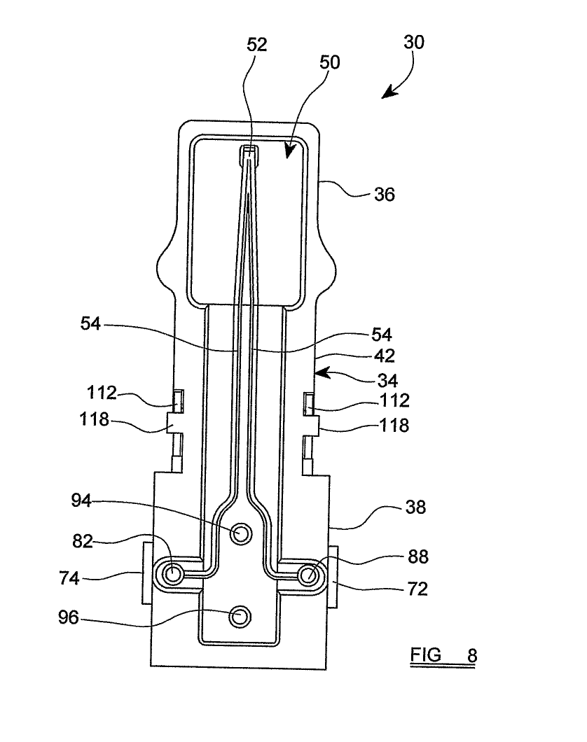

FIGS. 7 and 8 are exploded perspective and top views respectively of part of the temperature sensor assembly of FIG. 3, illustrating location of a first temperature-sensitive electrical element; and

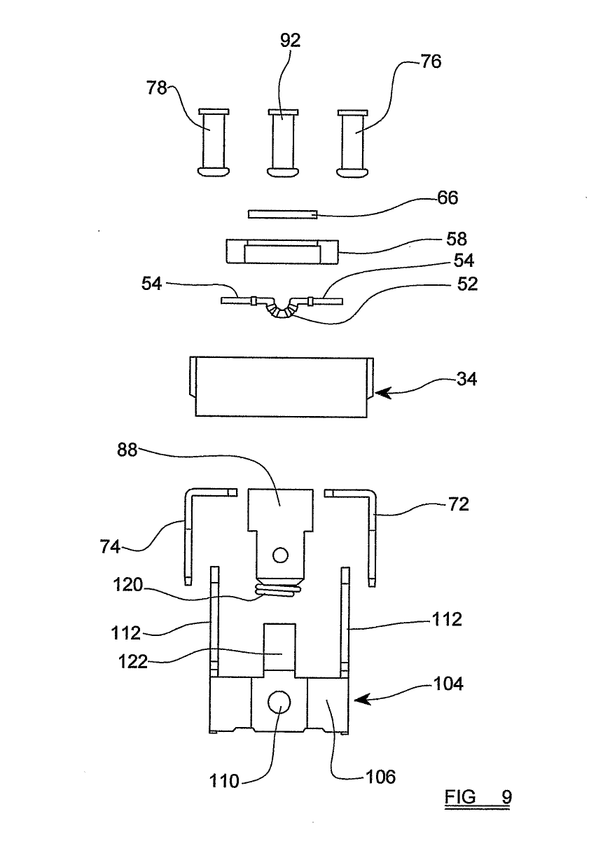

FIG. 9 is an exploded rear view of the temperature sensor assembly of FIG. 3.

Referring to FIGS. 1 and 2, an electrical heating arrangement 2 comprises a glass-ceramic cooking plate 4 of well-known form, having an upper surface 6 for receiving a cooking utensil 8, such as a pan. A lower surface 10 of the cooking plate 4 has an electric heater 12 supported in contact therewith. The electric heater 12 comprises a dish-like support 14, such as of metal, in which is provided a base layer 16 of thermal and electrical insulation material, such as microporous thermal and electrical insulation material. A peripheral wall 18 of thermal insulation material is arranged to contact the lower surface 10 of the cooking plate 4.

At least one radiant electrical resistance heating element 20 is supported relative to the base layer 16. The heating element or elements 20 can comprise any of the well-known forms of heating element, such as wire, ribbon, foil or lamp forms, or combinations thereof. In particular, the heating element or elements 20 can be of corrugated ribbon form, supported edgewise on the base layer 16 of insulation material.

It is to be understood, however, that the present invention is not limited to a heater incorporating at least one radiant electrical resistance heating element 20. Instead of, or in addition to, the radiant electrical resistance heating element or elements, at least one electrical induction heating element could be provided.

A terminal block 22 is provided at an edge region of the heater 12, for connecting the heating element or elements 20 to a power supply 24 by way of leads 26 and through a control means 28, which may be a microprocessor-based control arrangement.

The cooking utensil 8 is heated by the heating element or elements 20 and its temperature is monitored through the cooking plate 4 by a temperature sensor assembly 30, which will be described in detail hereinafter, and which is located in contact with the lower surface 10 of the cooking plate 4. The temperature sensor assembly 30 is also adapted to monitor temperature of the lower surface of the cooking plate 4 or of a cavity 32 formed between the heating element or elements 20 and the cooking plate 4.

Referring now to FIGS. 3 to 9, the temperature sensor assembly 30 comprises an elongate housing member 34 consisting of ceramic material, such as alumina, steatite or cordierite. The elongate housing member 34 is adapted to be mounted on the heater 12 to extend at least partially across the heater 12. A first end region 36 of the elongate housing member 34 is arranged to extend within the heater 12 from the inside of the peripheral wall 18 at least partially across the heater 12 and overlying, in spaced relationship with, the heating element or elements 20.

A second end region 38 of the elongate housing member 34 is arranged to traverse the peripheral wall 18, by way of a suitable slot or aperture 40 in the peripheral wall 18, and to extend externally of the peripheral wall 18.

The elongate housing member 34 is suitably provided with a waist-like region 42 for location in the slot or aperture 40 in the peripheral wall 18.

The first end region 36 of the elongate housing member 34 preferably has an external lower surface 44 contoured in such a way that thermal radiation 46 (FIG. 3) incident thereon from an underlying region or regions of the heating element or elements 20 is not substantially all reflected back to such underlying region or regions, where it could result in a local undesirably high temperature of the heating element or elements 20. The contoured external lower surface 44 of the first end region 36 of the elongate housing member 34 is provided of outwardly-bulging, bulbous or convex form or may have two or more inclined substantially planar faces such as to effect wide-angle reflection 48 of the incident thermal radiation 46 from the underlying heating element or elements 20. Such wide-angle reflection 48 of the incident thermal radiation 46 may be diffuse reflection. As a result, undesirable local high temperature of the region or regions of the heating element or elements 20 underlying the elongate housing member 34 is minimised or reduced.

The contoured external lower surface 44 of the first end region 36 of the elongate housing member 34 may be provided over substantially a full length of the first end region 36 extending within the heater 12 from inside the peripheral wall 18.

The elongate housing member 34 is provided with an elongate recess means 50 therein.

As particularly shown in FIGS. 7 and 8, a first temperature-sensitive electrical element 52 and first electrical leads 54 therefrom are arranged in the elongate recess means 50 and suitably in a groove arrangement 56 at a base of the elongate recess means 50. The first temperature-sensitive electrical element 52 is provided at the first end region 36 of the elongate housing member 34 and the first electrical leads 54 extend to the second end region 38 of the elongate housing member 34.

The first temperature-sensitive electrical element 52 comprises a device having an electrical parameter which changes as a function of temperature, such as a thermocouple or a device having an electrical resistance which changes as a function of temperature, such as a platinum resistance temperature detector. In particular, the first temperature-sensitive electrical element 52 comprises a chip-form electrical resistance temperature detector. The first electrical leads 54 are suitably of wire or tape form.

A layer 58 of thermal insulation material is provided in the elongate recess means 50 overlying the first temperature-sensitive electrical element 52 and at least part of the first electrical leads 54. The layer 58 of thermal insulation material is arranged to extend along at least the first end region 36 of the elongate housing member 34, that is the whole of the region of the elongate housing member 34 extending within the heater 12 from the inside of the peripheral wall 18. The layer 58 of thermal insulation material preferably also extends along at least part of the second end region 38 of the elongate housing member 34, at least where the second end region 38 traverses the peripheral wall 18 of the heater 12.

The layer 58 of thermal insulation material may also provide electrical insulation. It may comprise microporous thermal insulation material and/or granular thermal insulation material. Such granular thermal insulation material suitably comprises vermiculite or calcium silicate.

The layer 58 of thermal insulation material suitably has a thickness from about 1 mm to about 4 mm and preferably from about 2 mm to about 3 mm.

The layer 58 of thermal insulation material is suitably press-moulded into the elongate recess means 50 in the elongate housing member 34, over the first temperature-sensitive electrical element 52 and at least part of the first electrical leads 54.

A second temperature-sensitive electrical element 60 and second electrical leads 62 therefrom are arranged to overlie the layer 58 of thermal insulation material. The second temperature-sensitive electrical element 60 comprises a device having an electrical parameter which changes as a function of temperature. Although the second temperature-sensitive electrical element 60 and the second electrical leads 62 could be of similar form to the first temperature-sensitive electrical element 52 and the first electrical leads 54, the second temperature-sensitive electrical element 60 and the second electrical leads 62 are preferably provided of film or foil form on a thin elongate electrically insulating substrate 66 located in the elongate recess means 50 on top of the layer 58 of thermal insulation material. The second temperature-sensitive electrical element 60 suitably comprises a material such as platinum, whose electrical resistance changes as a function of temperature. The second electrical leads 62 may comprise the same material as, or a different material from, the element 60. The electrically insulating substrate 66 is provided in the elongate recess means 50 in the elongate housing member 34 such that the second temperature-sensitive electrical element 60 is located at the first end region 36 of the elongate housing member 34 and the second electrical leads 62 extend to the second end region 38 of the elongate housing member 34.

The electrically insulating substrate 66 may, for example, comprise alumina (such as of 87 to 99 percent purity), steatite, forsterite, glass-ceramic, fused silica, quartz, celsian, aluminium titanate, cordierite, zirconia, alumina-zirconia blends, silicon nitride, or a thin metal strip such as of stainless steel provided with a coating of dielectric material.

The electrically insulating substrate 66 suitably has a thickness from about 0.25 mm to about 3 mm and preferably from about 0.5 mm to about 1 mm.

One or more electrically insulating or passivation layers or members 64 may be provided overlying the second temperature-sensitive electrical element 60 and optionally the second electrical leads 62.

The second temperature-sensitive electrical element 60 may be arranged whereby an upper surface thereof is substantially coplanar with an upper surface 68 of the elongate housing member 34.

The layer 58 of thermal insulation material is preferably provided with an upstanding rim 70 laterally bordering one or more side edges of the second temperature-sensitive electrical element 60 on its supporting substrate 66.

The layer 58 of thermal insulation material serves to thermally insulate the second temperature-sensitive electrical element 60 from thermal radiation incident on the elongate housing member 34 from the heating element or elements 20 in the heater 12. Alternatively or additionally, the layer 58 of thermal insulation material provides protection for the first temperature-sensitive electrical element 52 and/or for the first electrical leads 54. Alternatively or additionally still, the layer 58 of thermal insulation material provides support for the second temperature-sensitive electrical element 60 and/or the second electrical leads 62, suitably by way of the substrate 66.

First electrical terminal means 72, 74 are secured at the second end region 38 of the elongate housing member 34 and electrically connected to ends 54A, 54B of the first electrical leads 54 by means of rivets, bolts or pins 76, 78 provided in holes 80, 82 through the second end region 38 of the elongate housing member 34. The first electrical terminal means 72, 74 are arranged for electrical connection of the first temperature-sensitive electrical element 52 to the control means 28 by way of leads 84 (FIG. 1).

Second electrical terminal means 86, 88 are also secured at the second end region 38 of the elongate housing member 34 and electrically connected to ends 62A, 62B of the second electrical leads 62 by means of rivets, bolts or pins 90, 92 provided in holes 94, 96 through the second end region 38 of the elongate housing member 34 and also provided in holes 98, 100 through the elongate substrate 66. By this means, the substrate 66 is also secured to the elongate housing member 34. The second electrical terminal means 86, 88 are arranged for electrical connection of the second temperature-sensitive electrical element 60 to the control means 28 by way of leads 102 (FIG. 1). If desired, one of the first electrical leads 54 and one of the second electrical leads 62 may be connected to a common terminal.

The first temperature-sensitive electrical element 52 is suitably arranged for monitoring temperature of the lower surface 10 of the cooking plate 4 or of the cavity 32 formed between the heating element or elements 20 and the cooking plate 4.

The second temperature-sensitive electrical element 60 is suitably arranged for monitoring temperature of the cooking utensil 8 through the cooking plate 4.

A mounting bracket 104 is provided for securing the elongate housing member 34 to the heater 12 and suitably comprises metal, such as steel, which may be plated with another metal or may be of stainless form. In order to ensure that the upper surface of the temperature sensor assembly 30 is located and maintained substantially in contact with the lower surface 10 of the cooking plate 4, it is arranged for the mounting bracket 104 to provide spring bias of the elongate housing member 34 towards the lower surface 10 of the cooking plate 4. It can be a problem to ensure that such spring biasing provides uniform contact between the upper surface of the temperature sensor assembly 30 and the lower surface 10 of the cooking plate 4. Such a problem is minimised or overcome by means of the following arrangement.

The mounting bracket 104 comprises a base portion 106, such as of contoured strip-like form, adapted to be secured to the dish-like support 14 at the edge of the heater 12, such as by a threaded fastener means 108 passing through a hole 110. A pair of spaced-apart substantially U-shaped slotted portions 112, having slots 114, extend from the base portion 106 and are adapted to slidingly engage complementary contoured opposite side regions of the elongate housing member 34. Such complementary contoured opposite side regions of the elongate housing member 34 comprise slots 116 containing web-like projections 118. The web-like projections 118 are able to slide up and down in the slots 114 of the U-shaped slotted portions 112 of the mounting bracket 104.

A compression coil spring 120 is provided on an upstanding locating portion 122 of the base portion 106 of the mounting bracket 104 and cooperates between the base portion 106 and an external lower surface region 124 (FIG. 4) at the second end region 38 of the elongate housing member 34, whereby the elongate housing member 34 is urged uniformly upwards towards and into contact with the lower surface 10 of the cooking plate 4. At the same time, relative sliding movement occurs between the web-like projections 118 on the elongate housing member and the slots 114 of the U-shaped slotted portions 112 of the mounting bracket 104.

Retaining means is provided for retaining the mounting bracket 104 in spring-loaded assembly with the elongate housing member 34. Such retaining means comprises a laterally extending lug portion 126 on one or both of the upstanding slotted portions 112 of the mounting bracket 104, adapted to engage with stop means 128 provided on one or both opposite side regions of the elongate housing member 34.

The upstanding slotted portions 112 of the mounting bracket 104 may be provided with hook-like projections 130 adapted to engage with slots or apertures in a rim of the dish-like support 14 of the heater 12, to provide more secure fixing of the mounting bracket 104 to the heater 12.

1. An electrical heating arrangement comprising: a cooking plate (4) having an upper surface (6) for receiving a cooking utensil (8), and a lower surface (10); an electric heater (12) incorporating at least one electric heating element (20), the heater having a peripheral wall (18) adapted for contacting the lower surface of the cooking plate; and a temperature sensor assembly (30), wherein the temperature sensor assembly comprises: a housing member (34) mounted on the heater and extending at least partially across the heater (12) and having a first end region (36) in spaced relationship with the at least one electric heating element (20), and a second end region (38) traversing and extending externally of the peripheral wall (18); a first temperature-sensitive electrical element (52) provided at the first end region (36) of the housing member (34) and having first electrical leads (54) extending to the second end region (38) of the housing member (34); a layer (58) of thermal insulation material; a second temperature-sensitive electrical element (60) separate from the first temperature-sensitive electrical element (52) and overlying the layer (58) of thermal insulation material, the second temperature-sensitive electrical element (60) being provided at the first end region (36) of the housing member (34) and having second electrical leads (62) extending to the second end region (38) of the housing member; and means (104) securing the housing member (34) relative to the heater (12) with an upper surface of the temperature sensor assembly (30) located substantially in contact with the lower surface (10) of the cooking plate (40).

2. An arrangement as claimed in claim 1, wherein the layer (58) of thermal insulation material overlies the first temperature-sensitive electrical element (52).

3. (canceled)

4. An arrangement as claimed in claim 1, wherein the second temperature-sensitive electrical element (60) is arranged whereby an upper surface thereof is substantially coplanar with an upper surface of the housing member (34).

5.-20. (canceled)

21. An arrangement as claimed in claim 1, wherein the first temperature-sensitive electrical element (52) is arranged for monitoring temperature of one of the lower surface (10) of the cooking plate (4), and a cavity (32) formed between the at least one heating element (20) and the cooking plate (4).

22. An arrangement as claimed in claim 1, wherein the second temperature-sensitive electrical element (60) is arranged for monitoring temperature of the cooking utensil (8) through the cooking plate (4).

23. (canceled)

24. An arrangement as claimed in claim 1, wherein the first end region (36) of the housing member (34) has an external lower surface (44) contoured in such a way that thermal radiation incident thereon from at least one underlying region of the at least one heating element (20) is not substantially all reflected back to such underlying region, whereby undesirably high temperature of the at least one heating element at such region is minimised or reduced.

25. An arrangement as claimed in claim 24, wherein contouring of the external lower surface (44) of the first end region (36) of the housing member (34) is such as to effect wide-angle reflection of the thermal radiation incident thereon from the underlying region or regions of the at least one heating element (20).

26. An arrangement as claimed in claim 25, wherein the wide-angle reflection of the incident thermal radiation is diffuse reflection.

27. An arrangement as claimed in claim 24, wherein the external lower surface (44) of the first end region (36) of the housing member (34) is contoured in a manner selected from outwardly-bulging form, bulbous form convex form and a form having at least two inclined substantially planar faces.

28. An arrangement as claimed in claim 24, wherein contouring of the external lower surface (44) of the first end region (36) of the housing member (34) extends over substantially a full length of the first end region adapted to extend within the heater (12) from the peripheral wall (18).

29. An arrangement as claimed in claim 1, wherein the layer (58) of thermal insulation material is provided with an upstanding rim (70) laterally bordering at least one side edge of the second temperature-sensitive electrical element (60).

30. An arrangement as claimed in claim 1, wherein the layer (58) of thermal insulation material extends along at least the first end region (36) of the housing member (34).

31. (canceled)

32. (canceled)

33. An arrangement as claimed in claim 1, wherein the layer (58) of thermal insulation material has a thickness from about 1 mm to about 4 mm.

34. An arrangement as claimed in claim 33, wherein the layer (58) of thermal insulation material has a thickness from about 2 mm to about 3 mm.

35. (canceled)

36. An arrangement as claimed in claim 1, wherein the means (104) for securing the housing member (34) to the heater (12) comprises a mounting bracket.

37. An arrangement as claimed in claim 36, wherein the mounting bracket (104) includes spring means (120) to bias the housing member (34) towards the lower surface (10) of the cooking plate (4), whereby the upper surface of the temperature sensor assembly (30) is located substantially in contact with the lower surface of the cooking plate.

38. An arrangement as claimed in claim 37, wherein the mounting bracket (104) comprises a base portion (106) secured to an external edge of the heater (12), and a pair of spaced-apart upstanding slotted portions (112) extending from the base portion and slidingly engaging complementary contoured opposite side regions (116, 118) of the housing member (34), compression coil spring means (120) being provided, cooperating between the base portion and an external lower surface region (124) of the housing member (34), whereby the housing member is urged towards the lower surface (10) of the cooking plate (4).

39. An arrangement as claimed in claim 38, wherein the base portion (106) of the mounting bracket (104) is of contoured strip-like form.

40. An arrangement as claimed in claim 38, wherein the base portion (106) is provided with an upstanding locating portion (122) for receiving the coil spring means (120).

41. An arrangement as claimed in claim 38, wherein the complementary contoured opposite side regions (116, 118) of the housing member (34) comprise slots (116) containing web-like projections (118) slidingly engaging the slotted portions (112) of the mounting bracket (104).

42. An arrangement as claimed in claim 38, wherein the upstanding slotted portions (112) of the mounting bracket (104) are substantially U-shaped.

43. An arrangement as claimed in claim 42, wherein the upstanding slotted portions (112) are open upwardly.

44. An arrangement as claimed in claim 38, wherein retaining means (126, 128) is provided for retaining the mounting bracket (104) in assembly with the housing member (34).

45. An arrangement as claimed in claim 44, wherein the retaining means comprises a laterally extending lug portion (126) on at least one of the upstanding slotted portions (112), engaging with stop means (128) provided on at least one opposite side region of the housing member (34).

46. An arrangement as claimed in claim 38, wherein the upstanding slotted portions (112) of the mounting bracket (104) are provided with hook-like projections (130) engaging with the external edge of the heater (12), to provide enhanced securement of the mounting bracket to the heater.
